(19) United States
(12) Patent Application Publication
(10) Pub. No.: US 2014/0092146 A1
(43) Pub. Date: Apr. 3, 2014

(54) DISPLAY CONTROL APPARATUS AND DISPLAY CONTROL METHOD

(71) Applicant: Fujitsu Mobile Communications Limited, Kawasaki-shi (JP)

(72) Inventor: Go HITAKA, Koshigaya (JP)

(73) Assignee: Fujitsu Mobile Communications Limited, Kawasaki-shi (JP)

(21) Appl. No.: 13/948,972

(22) Filed: Jul. 23, 2013

(30) Foreign Application Priority Data
Sep. 28, 2012 (JP) 2012-218241

(51) Int. Cl. G09G 5/10

(52) U.S. Cl. CPC G09G 5/10
USPC 345/690

(57) ABSTRACT

A display control apparatus includes a receiver configured to receive data via a network, a display controller configured to display information on a display unit based on the data received by the receiver, and a light source controller configured to lower luminance of a light source of the display unit in a predetermined period from a time at which the receiver starts receiving the data to a time at which the display controller completes displaying the information on the display unit, and restore the luminance after the predetermined period has elapsed.

### CROSS-REFERENCE TO RELATED APPLICATION

This application is based upon and claims the benefit of priority of the prior Japanese Patent Application No. 2012-218241, filed on Sep. 28, 2012, the entire contents of which are incorporated herein by reference.

### FIELD

The disclosures herein are generally related to a display control apparatus and a display control method.

### BACKGROUND

Mobile communication terminals such as smart phones and mobile phones may, in normal use, receive power from rechargeable batteries. Hence, reducing power consumption may be one of the important factors in order to use mobile terminals for a long-term period without charging the rechargeable batteries.

Among components of the mobile terminal, a backlight of a liquid crystal display (LCD) (hereinafter also called a “LCD backlight”) may be one of those components that require a large amount of power. Hence, reducing power consumption of the LCD backlight may effectively reduce the entire power consumption of the mobile terminal.

A related art technology disclosed, for example, in Japanese Laid-open Patent Publication No. 2002-176494 (hereinafter referred to as “Patent Document 1”) may provide a mobile terminal capable of lowering luminance of an LCD backlight when the mobile terminal has not continuously been operated in a predetermined period.

### RELATED ART DOCUMENTS

### Patent Document

Patent Document 1: Japanese Laid-open Patent Publication No. 2002-176494

However, in the above related art technology, an effect of reducing the power consumption of the mobile terminal, which is obtained by lowering the luminance of the LCD backlight, will not be acquired unless the mobile terminal has continuously been operated in the predetermined period.

### SUMMARY

According to one aspect of an embodiment, there is provided a display control apparatus including a receiver configured to receive data via a network; a display controller configured to display information on a display unit based on the data received by the receiver; and a light source controller configured to lower luminance of a light source of the display unit in a first predetermined period from a time at which the receiver starts receiving the data to a time at which the display controller completes displaying the information on the display unit, and restore the luminance after the first predetermined period has elapsed.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of an external appearance of a mobile terminal of an embodiment;

FIG. 2 is a diagram illustrating a hardware configuration example of the mobile terminal of an embodiment;

FIG. 3 is a diagram illustrating a functional configuration example of the mobile terminal of a first embodiment;

FIG. 4 is a flowchart illustrating an example of a procedure executed by the mobile terminal of the first embodiment; and

FIG. 5 is a diagram illustrating display transition examples of a touchscreen panel; and

FIG. 6 is a flowchart illustrating an example of a procedure executed by a mobile terminal of a second embodiment.

### DESCRIPTION OF EMBODIMENTS

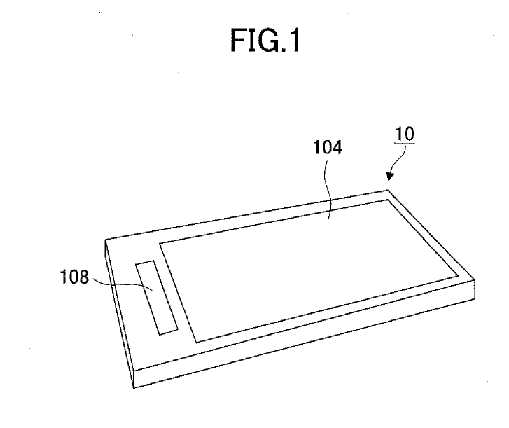

Preferred embodiments of the present invention will be described with reference to the accompanying drawings. FIG. 1 is a diagram illustrating an example of an external appearance of a mobile terminal of an embodiment.

As illustrated in FIG. 1, the mobile terminal 10 includes a touchscreen panel 104, and a hardware key 108 as externally viewable hardware. A user may perform input operations with respect to the mobile terminal 10 via the touchscreen panel 104 or the hardware key 108. The user may also browse information displayed on the touchscreen panel 104. Note that examples of the mobile terminal 10 may include smart phones and tablet terminals. Note that a mobile phone (i.e., a feature phone) not having the touchscreen panel 104 may also be utilized as the mobile terminal 10.

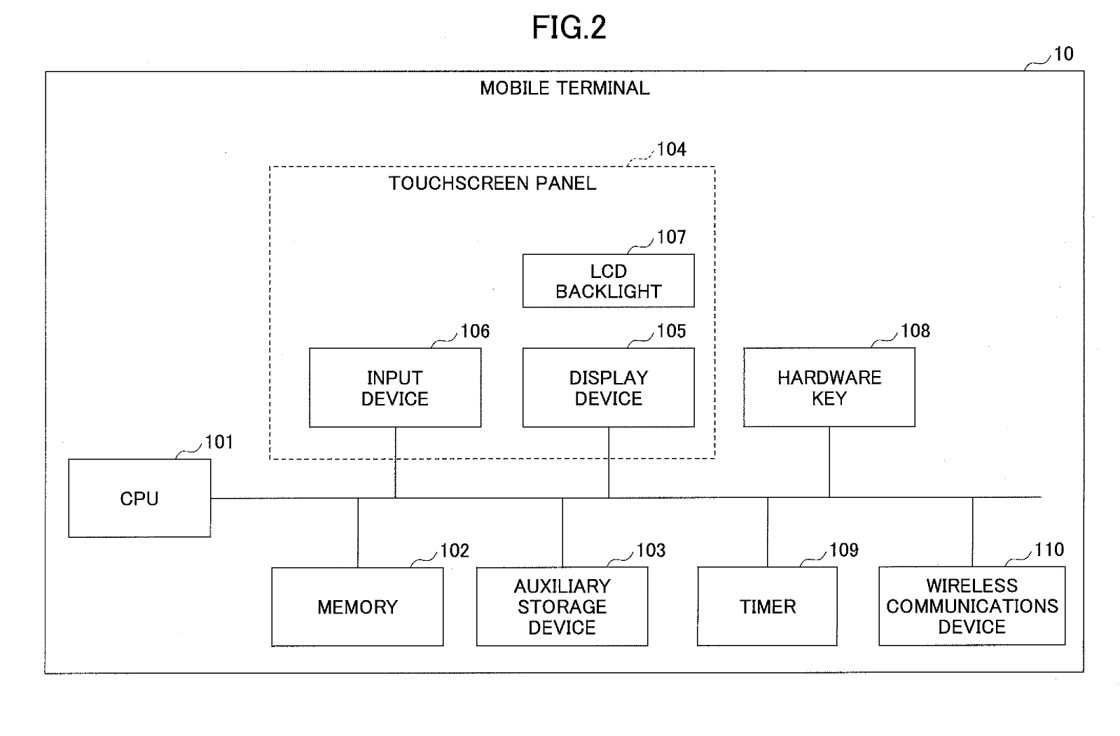

FIG. 2 is a diagram illustrating a hardware configuration example of the mobile terminal of the embodiment. As illustrated in FIG. 2, the mobile terminal 10 may include a central processing unit (CPU) 101, a memory 102, an auxiliary storage device 103, the touchscreen panel 104, the hardware key 108, a timer 109, and a wireless communication device 110.

The auxiliary storage device 103 may be configured to store programs installed on the mobile terminal 10. The memory 102 may be configured to retrieve a certain program from the auxiliary storage device 103 and store the program when the mobile terminal 10 receives an instruction to activate the program. The CPU 101 may be configured to implement functions associated with the mobile terminal 10 in compliance with the program stored in the memory 102.

The touchscreen panel 104 may be an electronic component having an input function and a display function such that the touchscreen panel 104 may receive an input from the user, or display information. The touchscreen panel 104 may include a display device 105, an input device 106, and a liquid crystal display (LCD) backlight 107.

The display device 105 may be a liquid crystal display (LCD) or the like, and serve as the display function of the touchscreen panel 104. The input device 106 may be an electronic component including a sensor configured to detect a contact object when the contact object comes in contact with the display device 105. The contact object being in contact with the display device 105 may be detected by any one of methods known in the art including an electrostatic method, a resistive method, and an optical method. Note that the contact object may be any objects that come in contact with the touchscreen panel 104. Examples of the contact object may include a user's finger, a dedicated pen, a general pen, or the like. The LCD backlight 107 may be a light source disposed on a rear surface of the display device 105. The illumination or light-emission of the LCD backlight 107 may improve the viewability of the information displayed on the display device 105.

The hardware key 108 may be a button or a key configured to receive an input of a predetermined instruction. The timer 109 may be configured to measure progression of time. The wireless communication device 110 may be an electronic component such as an antenna necessary for performing communications in a wireless local area network (LAN) or a mobile communication network.

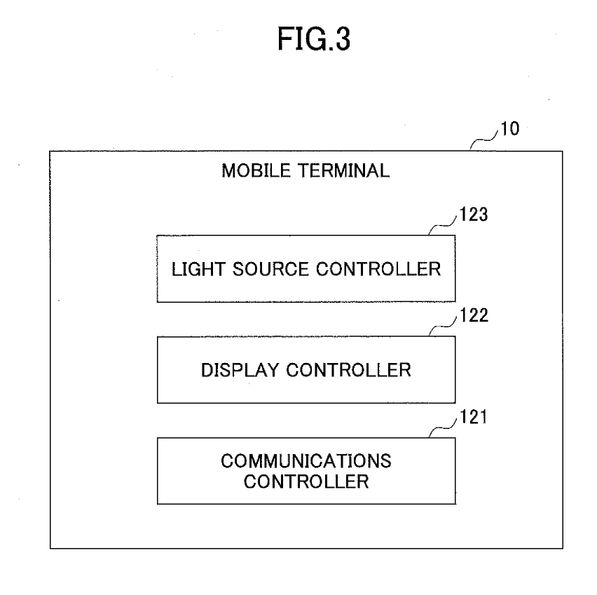

FIG. 3 is a diagram illustrating a functional configuration example of the mobile terminal of a first embodiment. In FIG. 3, the mobile terminal 10 may include a communications controller 121, a display controller 122, and a light source controller 123. These components may be implemented by causing the CPU 101 to execute one or more programs installed on the mobile terminal 10. Note that the programs may be stored in the auxiliary storage device 103 of the mobile terminal 10 in advance, or may be downloaded via the network.

The communications controller 121 may be configured to control wireless communications via the wireless communication device 110. In the first embodiment, the communications controller 121 may control the reception of content data via the network. The content data may include recorded display information. An example of the content data may include a Web page described in a hypertext markup language (HTML). Note that the content data may be any data other than the Web page insofar as the data includes the display information.

The display controller 122 may be configured to implement a browser function to display the content data received by the communications controller 121 on the display device 105. The light source controller 123 may be configured to control luminance (i.e., brightness) of the LCD backlight 107.

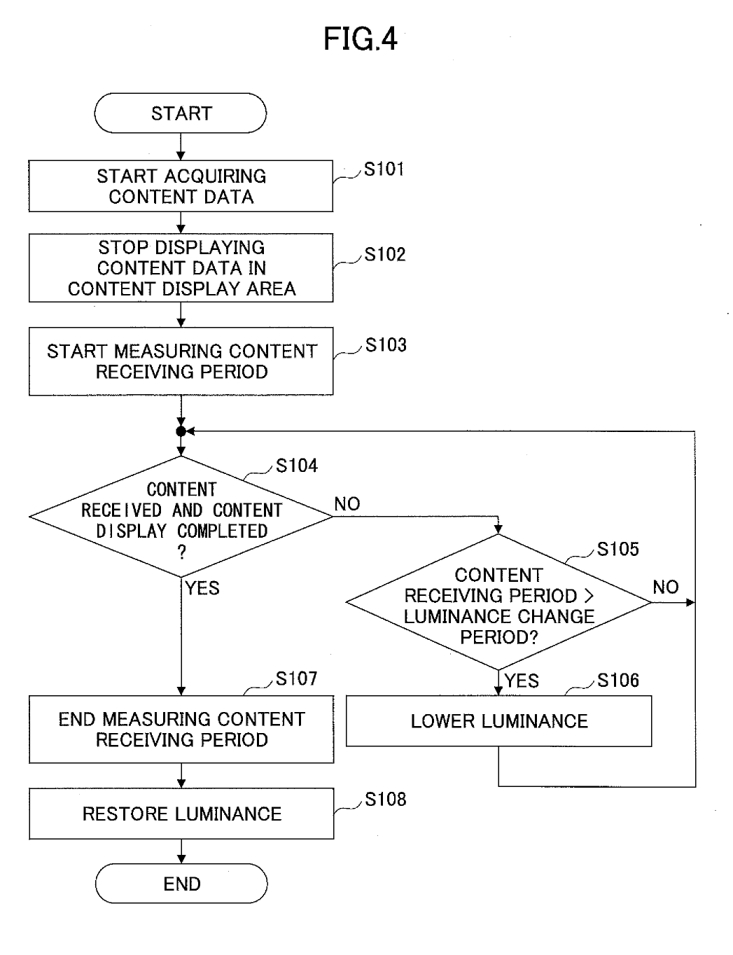

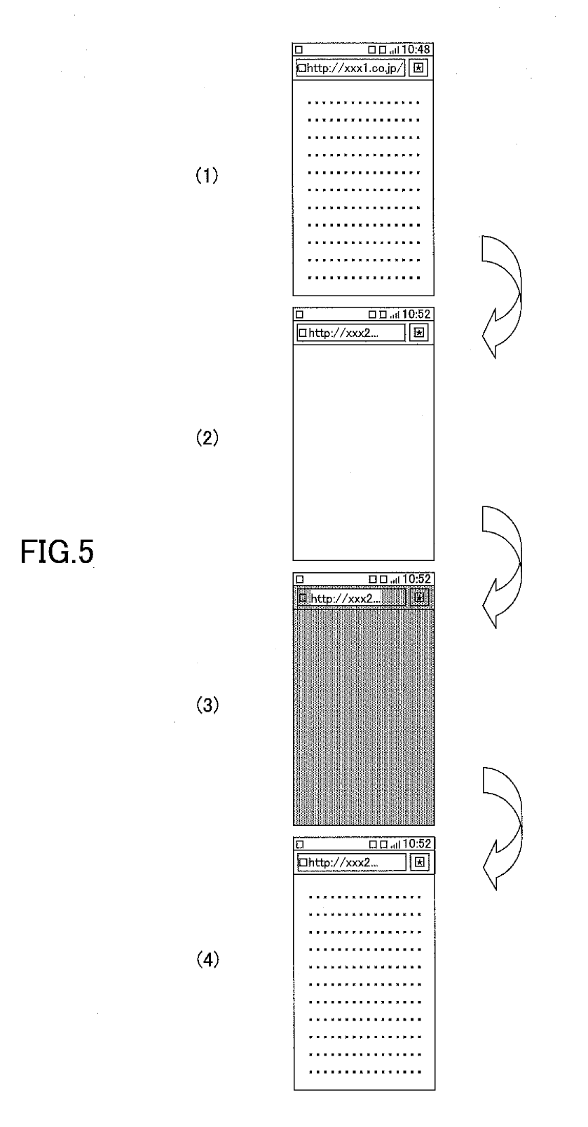

A description will be given below of a procedure executed by the mobile terminal 10. FIG. 4 is a flowchart illustrating an example of the procedure executed by the mobile terminal 10 of the first embodiment. Further, FIG. 5 is a diagram illustrating a display transition example of the touchscreen panel 104. As illustrated in (1) of FIG. 5, the touchscreen panel 104 may exhibit a display status in which some kind of content data are displayed at a start point of the procedure illustrated in FIG. 4. Note that an initial status of the mobile terminal 10 may be a

The communications controller 121 may start acquiring content data by performing communications over the network in response to automatic updates based on definitions of the displayed content data or the user's operations via the hardware key 108 or the input device 106 (step S101). That is, a content data acquisition request may be transmitted to an address (e g , uniform resource locator URL) of a content data acquiring destination.

The display controller 122 stops displaying the display information, which has just been displayed in a content display area of a browsing screen presented on the display device 105 in response to the content data that starts being acquired (S102). As a result, the display status of the touchscreen panel 104 may be switched from the status (1) to the status (2) illustrated in FIG. 5. In this stage, the content display area of the browsing screen may be blank. However, a message or the like may be displayed in the content display area of the browsing screen in order to inform a user of the fact that the content data is currently being received. Note that a status of a period between a time at which the content data starts being acquired (i.e., the start of the content data acquisition) and a time at which the content data completes being displayed (i.e., the completion of the content data display) may be called a “content receiving status”. The “completion of the content data display” indicates the completion of the display of the display information recorded in the content data. The “display information recorded in the content data” may include data (e.g., image data) held by linked destinations of the content data in addition to the display information of the content data themselves. That is, more than one communication may be required for receiving the content data. Note that each communication may include one reciprocation consisting of transmission of a content data acquisition request and reception of the content data in response to the content data acquisition request. After the content data are received, the reception of the content data may be incomplete until the data acquisition request has been transmitted to every link destination of the content data, and each of the link destinations has received the transmitted content data in response to the content data acquisition request.

Subsequently, the light source controller 123 may start measuring the period (i.e., progression of time) of the content data receiving status utilizing the timer 109 (step S103). When the period of the content receiving status (i.e., a content receiving period: a first predetermined period) exceeds a predetermined luminance change period (e.g., a few second or a few milliseconds: a second predetermined period) during a period between a time where the communication controller 121 receives the content data and a time where the display controller 122 completes displaying the content data (“No” in step S104), the light source controller 123 may lower the luminance (i.e., the brightness) of the LCD backlight 107 such that a luminance value of the LCD backlight may be lower than a current luminance value of the LCD backlight by a predetermined amount (step S106). As a result, the display status of the touchscreen panel 104 may be switched from the status (2) to the status (3) illustrated in FIG. 5. The status (3) of FIG. 5 illustrates a lowered luminance status of the LCD backlight 107. Note that the “luminance change period” (i.e., a second predetermined period) indicates timing and a period in which the luminance of the LCD backlight 107 is changed (i.e., lowered) with respect to the period of the content receiving status. That is, the luminance of the LCD backlight 107 is changed (i.e., lowered) in the period of the content receiving status (i.e., the first predetermined period) after the luminance change period (i.e., the second predetermined period) has elapsed from the time at which the receiver starts receiving the data. The luminance change period or the amount of luminance to be lowered may be defined as setting information that may be set by the user.

Subsequently, when the reception and the display of the content data are completed (“Yes” in step S104), the light source controller 123 may end measuring the period of the content receiving status (step S107). Subsequently, the light source controller 123 may restore the luminance of the LCD backlight 107 to the previous luminance status before the luminance has been lowered (step S108). As a result, the display status of the touchscreen panel 104 may be switched from the status (3) to the status (4) illustrated in FIG. 5. That is, newly received content data may be displayed at a normal luminance.

On the other hand, when the reception and the display of the content data are completed (“Yes” in step S104) before the period of the content receiving status exceeding the luminance change period (“No” in step S105), processes in steps S107 and 108 may be carried out without lowering the luminance of the LCD backlight 107. In this case, no substantial process may be carried out in step S108.

Further, when the user inputs an instruction to discontinue the display of the content data or instructions to activate other functions in the content receiving status, the light source controller 123 may restore the luminance of the LCD backlight 107.

Note that the reason for not lowering the luminance of the LCD backlight 107 immediately after the initiation of the content receiving status may be to prevent the screen from flickering when the reception or the display of the content data are completed in a short time (i.e., a short period). That is, when the reception or the display of the content data are completed immediately after the initiation of the content receiving status, the user may perceive the screen as being instantaneously brightened up once the screen becomes dim. The user may feel such screen behaviors unnatural. Hence, according to the first embodiment, the luminance of the LCD backlight 107 may be lowered when the reception or the display of the content data are not completed even though the luminance change period has elapsed. Note that the luminance of the LCD backlight 107 may be lowered approximately at the same time as the mobile terminal 10 starts acquiring the content data or transmits the content data acquisition request.

Further, the display controller 122 may partially display the content data to be browsed before the reception of all the content data (including data held by the linked destinations) has been completed in order to improve the operability and the responsiveness of the mobile terminal. Partially displaying the content data may include displaying image data with lower resolution in addition to displaying parts of the content data regionally. When the luminance of the LCD backlight 107 remains lowered in the above condition until the display of all the content data has been completed, the operability of the mobile phone may be degraded. Accordingly, the timing to restore the luminance of the LCD backlight 107 may be set before the display of all the content data has been completed. That is, the period in which the luminance of the LCD backlight 107 is lowered may appropriately be determined in a predetermined period from a time at which the content data starts being acquired to a time at which the content data completes being displayed. In other words, the period in which the luminance of the LCD backlight 107 is lowered may be any period obtained by excluding the luminance change period within the predetermined period. The predetermined period may be varied based on the displays of the different sets of the content data.

Further, when the display information is partially updated, the LCD backlight 107 may be set such that the luminance of the LCD backlight 107 will not be changed. This may be because the user may browse unupdated parts of the display area of the browsing screen.

As described above, the mobile terminal according to the first embodiment may lower the luminance of the LCD backlight 107 in a period in which high viewability is not necessarily required. Hence, power consumption of the mobile terminal 10 may be lowered while suppressing the degradation of its operability.

Since the power consumption is lowered, it may be possible to prolong durability of a rechargeable battery in the mobile terminal 10. Further, since durability equivalent to that of the related art rechargeable battery is realized in a rechargeable battery having a smaller capacity, cost of the mobile terminal 10 may also be reduced.

Next, a mobile terminal according to a second embodiment will be described. In the following description of the second embodiment, parts of the second embodiment differing from those of the first embodiment will mainly be described. Hence, those of the second embodiment being not specifically referred to in the following description may be similar to those of the first embodiment. In the mobile terminal of the second embodiment, a description will be given of an example of the luminance change period that may be varied based on a communication status of the mobile terminal. More specifically, it may be assumed that a longer time is required until the reception and the display of the content data have been completed in a bad radio wave signal reception condition. Hence, a shorter luminance change period may be set in this case. Further, it may be assumed that a substantial amount of time is required until the reception and the display of the content data have been completed when the mobile terminal 10 is not capable of receiving radio wave signals; that is, when the mobile terminal 10 resides outside the service area. Hence, the luminance change period may none (zero) in this case. Accordingly, when the mobile terminal 10 is unable to receive the radio wave signals, the luminance of the LCD backlight 107 may be lowered approximately at the same time as the mobile terminal 10 starts acquiring the content data. That is, the luminance of the LCD backlight 107 may be immediately lowered when the mobile terminal 10 starts acquiring the content data.

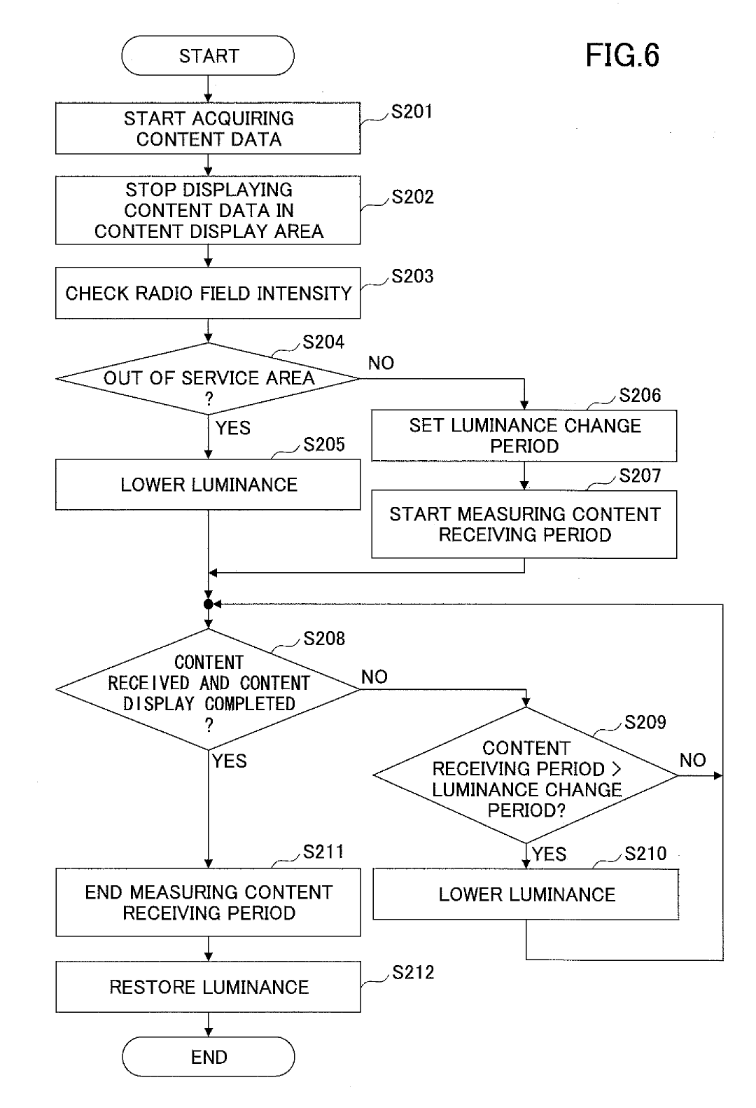

FIG. 6 is a flowchart illustrating an example of a procedure executed by a mobile terminal of the second embodiment.

Processes of steps S201 and S202 in FIG. 6 may be similar to those of steps S101 and S102 in FIG. 4. In step S203, the light source controller 123 may check the radio wave intensity detected by the wireless communication device 110. When the radio wave intensity is not high enough to perform communications; that is, when the mobile terminal 10 resides outside the service area (“Yes” in step S204), the light source controller 123 may lower luminance (i.e., brightness) of the LCD backlight 107 such that a value of the luminance is lower than a current value of the luminance by a predetermined amount.

On the other hand, when the radio wave intensity is high enough to perform communications (“No” in step S204), the light source controller 123 may set a period appropriate to the radio wave intensity as the luminance change period (step S206). For example, luminance change period corresponding to the maximum value of the radio wave intensity may be determined in advance, a ratio of the current radio wave intensity to the maximum value of the radio wave intensity may be multiplied by the luminance change period so as to compute appropriate luminance change period (i.e., the period appropriate to the radio wave intensity). Alternatively, the luminance change period corresponding to each of radio wave intensity ranges may be associated with each of the radio wave intensity ranges so as to be stored in the auxiliary storage device 103 or the like. In either of the above cases, the higher the radio wave intensity is, the longer the luminance change period will be set.

Subsequently, the light source controller 123 may start measuring a period (i.e., progression of time) of the content receiving status utilizing the timer 109 (step S207).

Subsequent processes of steps S208 to and S222 in FIG. 6 may be similar to those of steps S104 to S108 in FIG. 4. Note that the luminance change period set in step S206 may be utilized in step S208. Further, in the processes subsequent to step S208, when the radio wave signal reception condition is changed before the luminance change period has elapsed, the luminance change period may be set in compliance with the changed radio wave signal reception condition. For example, when the radio wave signal reception condition of the mobile terminal indicates outside the service area, the luminance change period may be set to “0” so as to immediately lower the luminance of the LCD backlight.

Note that in the above example, the communication status of the mobile terminal may be determined based on the radio wave intensity; however, the communication status of the mobile terminal may alternatively be determined based on data transfer rate per unit time. In this case, the smaller the amount of data received within a predetermined time from a time at which the content data starts being received is, the shorter the luminance change period may be set.

As described above, in the mobile terminal of the second embodiment, the luminance change period may be changed based on the communication status of the mobile terminal. Hence, the power consumption may more effectively be reduced in a case where a longer time (a period) is assumed to be required for receiving the content data.

Note that in the above embodiments, the control of the LCD backlight 107 is described. However, when the hardware key 108 or the like includes a backlight, the backlight of the hardware key 108 or the like may be controlled in a manner similar to the control of the LCD backlight 107. In this case, the luminance change period of the backlight of the hardware key 108 or the like may be the same as or different from that of the LCD backlight 107.

Further, the above embodiments may be applied to a personal computer (PC) and the like insofar as the PC serves as an information processing apparatus having a browser function.

Further, the content data are received via the wireless communications in the above embodiments; however, the content data may be received via a wired network.

Note that in the above embodiments, the mobile terminal 10 may be an example of the display control apparatus. The communication controller 121 may be an example of a receiver. The display device 105 may be an example of a display unit.

According to an aspect of the embodiments, there is provided a display control technology to reduce power consumption that may be required for displaying information on an apparatus such as a mobile terminal.

According to an aspect of the embodiments, the power consumption may be reduced, which appears to be necessary for the display of the information.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A display control apparatus comprising:
a receiver configured to receive data via a network;
a display controller configured to display information on a display unit based on the data received by the receiver; and
a light source controller configured to lower luminance of a light source of the display unit in a first predetermined period from a time at which the receiver starts receiving the data to a time at which the display controller completes displaying the information on the display unit, and restore the luminance after the first predetermined period has elapsed.

2. The display control apparatus as claimed in claim 1, wherein
the light source controller lowers the luminance of the light source of the display unit in the first predetermined period after a second predetermined period has elapsed from the time at which the receiver starts receiving the data.

3. The display control apparatus as claimed in claim 2, wherein
the light source controller changes the second predetermined period based on a communication status for receiving the data.

4. A display control method executed by a display control apparatus, the display control method comprising:
receiving data via a network;
displaying information on a display unit based on the received data;
lowering luminance of a light source of the display unit in a first predetermined period from a time at which the data starts being received to a time at which the information completes being displayed; and
restoring the luminance after the first predetermined period has elapsed.

5. The display control method as claimed in claim 4, wherein
the lowering the luminance includes lowering luminance of the light source of the display unit in the first predetermined period after a second predetermined period has elapsed from the time at which the data starts being received.

6. The display control method as claimed in claim 5, wherein
the lowering the luminance includes changing the second predetermined period based on a communication status for receiving the data.

7. A non-transitory computer-readable storage medium storing a program which, when executed by a processor, causes a display control apparatus to perform a process comprising:
receiving data via a network;
displaying information on a display unit based on the received data;
lowering luminance of a light source of a display unit in a first predetermined period from a time at which the data starts being received to a time at which the information completes being displayed; and
restoring the luminance after the first predetermined period has elapsed.

8. The non-transitory computer-readable storage medium as claimed in claim 7, wherein
the lowering the luminance includes lowering luminance of the light source of the display unit in the first predetermined period after a second predetermined period has elapsed from the time at which the data starts being received.

9. The non-transitory computer-readable storage medium as claimed in claim 8, wherein
the lowering the luminance includes changing the second predetermined period based on a communication status for receiving the data.
